(19) United States
(12) Patent Application Publication
(10) Pub. No.: US 2021/0374822 A1
(43) Pub. Date: Dec. 2, 2021

(54) SYSTEM AND PROCESS FOR THE IDENTIFICATION OF A USER-SELECTED ARTICLE, PRESENTATION OF DATA THEREOF AND ACQUISITION OF USER INTERACTION THEREWITH

(71) Applicant: AI GASPAR LIMITED, Hong Kong (CN)

(72) Inventors: Wai Keung YEUNG, Hong Kong (CN); Wai LAU, Hong Kong (CN); Chik Yun lan KWAN, Hong Kong (CN); Pui Hang KO, Hong Kong (CN); Wing Chiu LIU, Hong Kong (CN); Jianxiang YU, Hong Kong (CN)

(73) Assignee: AI GASPAR LIMITED, Hong Kong (CN)

(21) Appl. No.: 17/277,557

(22) PCT Filed: Sep. 18, 2019
(86) PCT No.: PCT/CN2019/106519

§ 371 Date: Mar. 18, 2021

(30) Foreign Application Priority Data
Sep. 18, 2018 (HK) 18112003.0
Nov. 15, 2018 (HK) 18114655.7

(51) Int. Cl. G06Q 30/06; H04N 9/31; G06K 9/00; G06K 9/32; G06N 3/08

(52) U.S. Cl. CPC G06Q 30/0623; H04N 9/3194; G06K 9/00671; G06K 9/00302; G06Q 30/0631; G06K 9/00771; G06Q 30/0643; G06N 3/08; G06K 9/3233

(57) ABSTRACT

A computerized system for providing article information to a customer, said system comprising an optical image acquisition device for acquiring an optical image of an area of interest (AOI) in which articles are display to a customer, a processor module operably in communication with the optical image acquisition device and for receiving an image input signal therefrom; and an output device in communication with the processor for providing an output signal to a customer: wherein upon the processor detecting the article being removed from the area of interest (AOI), the processor sends an output signal having article data associated with said article to said output device, and said output device provides an output to the customer of said article data.

### TECHNICAL FIELD

The present invention relates to a system and process for the identification of a user-selected article, in particular the present invention provides a system and process for presentation of data thereof and acquisition of user interaction therewith.

### BACKGROUND OF THE INVENTION

Currently, products and items are being placed on shelf, display counter and other furniture fixture at retail stores for consideration by consumers and potential customers, who may review and assess such products, with a view to purchase such product.

As such products and items are removeable shelf, display counter and other furniture fixture, it can be difficult to consistently provide correct item or article information, specifications and commercial and technical information for review by consumers and potential customers.

Furthermore, it can also be difficult for retailers to track or monitor a consumer or potential customer's shopping behavior, their interest level and appeal towards particular product or item and whether a consumer or potential customer has picked up product for viewing and consideration.

### OBJECT OF THE INVENTION

It is an object of the present invention to provide a system and process to identify a user-selected article, which overcomes or ameliorates at least some deficiencies as associated with the prior art.

### SUMMARY OF THE INVENTION

In a first aspect, the present invention provides a computerized system for providing article information to a customer, said system comprising:

an optical image acquisition device for acquiring an optical image of an area of interest (AOI) in which articles are display to a customer;

a processor module operably in communication with the optical image acquisition device and for receiving an image input signal therefrom; and

an output device in communication with the processor for providing an output signal to a customer;

wherein upon the processor detecting the article being removed from the area of interest (AOI), the processor sends an output signal having article data associated with said article to said output device, and said output device provides an output to the customer of said article data.

Preferably, the output device is a projector device, and wherein said projector device provides visual article data, and preferably said AOI is a table

Preferably the projector device projects the article data onto said table.

Preferably, the processor determines said article by way of artificial intelligence (AI).

Preferably, the system utilises optical recognition of facial expressions, so as to ascertain the appeal by a subject in relation to said article.

Preferably, the output device is a projector device, and the processor ascertains the position of the article in the AOI in real time, and the projector device provides an image to the AOI in real time.

Preferably, the AOI is a table, and the image is a representation of a spotlight.

In a second aspect, the present invention provides a process operable using a computerized system for providing article information to a customer, the computerized system including an optical image acquisition device, an output device in communication with the processor for providing an output signal to a customer, said process including the steps of:

obtaining an optical image of one or more articles in an area of interest (AOI) a subject using optical image acquisition device;

by the processor, determining if an article has been removed by a customer from the AOI; and

by output device the providing article information to a customer.

### BRIEF DESCRIPTION OF THE DRAWINGS

In order that a more precise understanding of the above-recited invention can be obtained, a more particular description of the invention briefly described above will be rendered by reference to specific embodiments thereof that are illustrated in the appended drawings.

FIG. 1 shows a schematic representation of a system according to the present invention;

FIG. 2 shows the camera and projector setup in one of the embodiments of the present invention.

FIG. 3a shows the perspective view of the projecting surface captured by the camera in one of the embodiments of the present invention.

FIG. 3b shows the mapping of corners and any point within the area from the camera coordinates to projector coordinates,

FIG. 4 shows the calculation outputs of the coordinates of the centers of the articles derived by the AI system.

FIG. 5 shows the center points of the articles detected in the camera image.

FIG. 6 shows the center points of the articles in the projector output coordinates.

FIG. 7 shows the projection on the AOI when articles being picked up from the projecting surface.

FIG. 8 shows the corresponding projector output image when no articles being picked up from the projecting surface,

FIG. 9 shows the projection of the AOI when an article is picked up from the projecting surface,

FIG. 10 shows the corresponding projector output image when an image is picked up from the projecting surface.

### DETAILED DESCRIPTIONS OF THE DRAWINGS

The present invention provides a system and process for delivering information to a customer, and acquiring sales and market-based information,

Main Purpose:

A main purpose of the present invention is to provide sale assistance to customers, which may also include a novel interactive response.

The system of the present invention determines what attributes and characteristics of articles for sale that a customer may be interested in; as well as and related multi-media advertisement; sales assistance information such as pricing, product of related brand, style, available colour and size and the like, which may be provided in either or both video and audio formats.

The system can also determine from a customer's facial expression the level of interest by a customer in a product, and data may be collected for sales analytics in this regard, as well as product detail.

Furthermore, the system may retailers to track or monitor a consumer or potential customer's shopping behavior, their interest level and appeal towards particular product or item and whether a consumer or potential customer has picked up product for viewing and consideration, which provides useful commercial information to further assist customers.

Product Range:

The system of the present invention may be applied to any products having an optically identifiable appearance. An embodiment using shoes is used as an example.

AI (Artificial Intelligence) Article Detection

In preferred embodiment of the present invention, the article may be identified by way of an Artificial Intelligence (AI) system: An example of such an AI system is “You only look once (YOLO)”, which is a state-of-the-art, real-time article detection system. It is currently free of charge, and allows for ease of tradeoff between speed and accuracy simply by changing the size of the model, with no retraining being required. As will be understood, other trained AI engines or Neural Networks could also be used.

The AI system is trained with thousands of facial images so that the system is able to detect customer's face, his/her facial expression and identify age group and gender.

The system can identify whether a customer is happy or not with product by detecting the smiling level, or other types of facial expression indicative of mood response to a stimuli.

Once faces are identified by the AI system in an image, the faces are then overlaid by rectangles, and such rectangles seek to bound the boundaries of the face images.

The coordinates of the rectangles, as well as other identified information, such as the age, gender, emotion and coordinates of face features such as eyes, ears, mouth, nose, etc. can be output to a text file.

An AI engine, which may be the same or another AI engine, that was trained with thousands of article or product images so that the system is able to detect the brand, type, style, colour, size, and other related properties of the same kinds of articles or products can be used.

The system supports multiple article of article detection. Once articles or objects are identified by the AI system in an image, the articles are then overlaid by rectangles.

The rectangles try to bound the boundaries of the article. The coordinates of the rectangles, as well as other identified information, such as the brand, type, style, colour, size, and other related properties, are output to a text file.

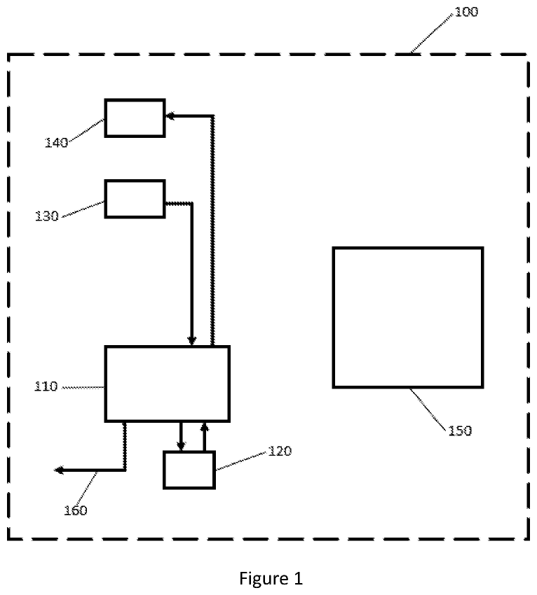

Referring to FIG. 1, an embodiment of a system 100 according to the present invention is shown, which includes a processor 110, a data store 120, an optical image acquisition device 130 and an output device 140.

In embodiment of the present invention, the output device 140 is an visual output display device, such as a projector or a video screen, for example.

Within the system, there is a display area denoted by 150, which may be a visual output display region.

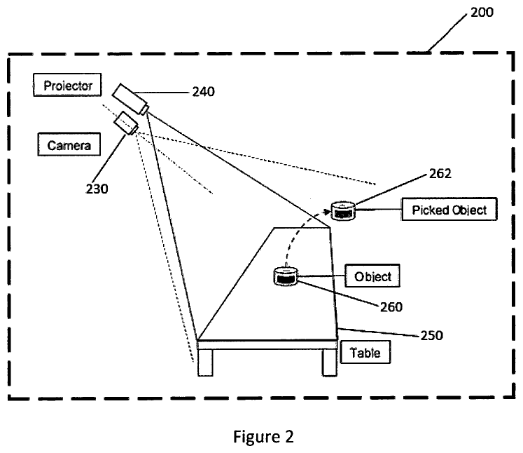

Referring now to FIG. 2, there is shown an embodiment of a system 200 according to the present invention. The system 200 includes a camera 230 as the optical image acquisition device and a projector 240 as the output device.

In the present embodiment, the camera 230 is set up so that it captures a whole Area of Interest (AOI), such as a table 250, a wall, a floor, or any other flat surface suitable for projecting images onto it.

The camera 230 image covers the AOI 250, and a portion of space outside the AOI.

The space outside the AOI is for analyzing whether an article has be picked up or taken away from the table 250 by the customer. As shown in FIG. 2, by way of example, the camera 230 image covers the whole table 250, as well as a portion of space above the table.

As also shown in FIG. 2, the projector 240 is setup so that the full screen projected by the projector 240 is well aligned to the AOI. In this example, the four corners of the projector output are well aligned with the four corners of the table.

Projective Mapping

As mentioned, real time images or videos of the AOI are captured by the optical image acquisition device set above the AOI.

For calculation and positioning purposes, any skewness or distortion of the capture images of the AOI are unwanted since it may lead to discrepancies to the ideal rectangular coordinate system.

However in reality, it is usually not possible to align the camera perfectly on top of the AOI surface, for example a table, and that the image of the table captured by the camera may always appear tilted and distorted.

As such, before the system is utilised, a calibration process is required in order to generate a projective transformation matrix. The matrix relates the coordinates in pixel of the four corners of the table 250 appearing in the camera 230 image to the four corners of the projector 240 output.

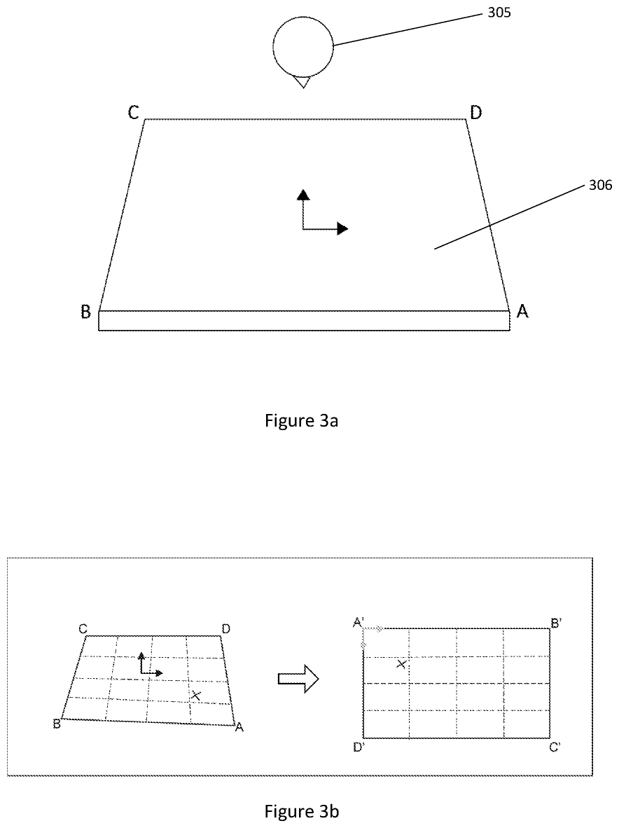

FIG. 3a illustrates the perspective view of the table 306 with corners A, B, C and D being captured by the camera 305 when the camera is not perfectly aligned on top of the table 306. A calibration process is therefore required to generate a projective transformation matrix. As shown in FIG. 3b, the coordinates of the table corners A, B, C and D in pixel in the image captured by the camera are transformed to the four corners A′, B′, C′ and D′ of the projector 240 output image.

Note that the point A is at the lower bottom side of the camera image, but it becomes the top left corner of the projector image from the customer's point of view.

Any point, as indicated by “X” mark in FIG. 3b, within the table is then related to the projector output with linear interpolation.

By defining the transformation of coordinates by these equations:

$${x}_{{K}^{′}} = \frac{{v}_{1} {x}_{K} + {v}_{2} {y}_{K} + {v}_{3}}{{v}_{7} {x}_{K} + {v}_{8} {y}_{K} + 1} \\ {y}_{{K}^{′}} = \frac{{v}_{4} {x}_{K} + {v}_{5} {y}_{K} + {v}_{6}}{{v}_{7} {x}_{K} + {v}_{8} {y}_{K} + 1}$$

where

(x_{K}, y_{K}) are the coordinates of a point in pixel in the camera image and

(x_{K}y_{K},) are the coordinates of the corresponding point in the projector output image.

In matrix form,

$$[ \begin{matrix}{x}_{{ }_{Ko}} \\ {y}_{Ko} \\ w\end{matrix} ] = [ \begin{matrix}{v}_{1} & {v}_{2} & {v}_{3} \\ {v}_{4} & {v}_{5} & {v}_{6} \\ {v}_{7} & {v}_{8} & 1\end{matrix} ] [ \begin{matrix}{x}_{{ }_{K}} \\ {y}_{K} \\ 1\end{matrix} ] \\ [ \begin{matrix}{x}_{{K}^{′}} \\ {y}_{{K}^{′}}\end{matrix} ] = [ \begin{matrix}{x}_{K o} \\ {y}_{K o}\end{matrix} ] / w$$

Consider mapping of all 4 corners (A,B,C,D) to (A′, B′, C′, D′)

$$[ \begin{matrix}{x}_{{A}^{′}} \\ {y}_{{A}^{′}} \\ {x}_{{B}^{′}} \\ {y}_{{B}^{′}} \\ {x}_{{C}^{′}} \\ {y}_{{C}^{′}} \\ {x}_{{D}^{′}} \\ {y}_{{D}^{′}}\end{matrix} ] = [ \begin{matrix}{x}_{A} & {y}_{A} & 1 & 0 & 0 & 0 & - {x}_{A} {x}_{{A}^{′}} & - {y}_{A} {x}_{{A}^{′}} \\ 0 & 0 & 0 & {x}_{A} & {y}_{A} & 1 & - {x}_{A} {y}_{{A}^{′}} & - {y}_{A} {y}_{{A}^{′}} \\ {x}_{B} & {y}_{B} & 1 & 0 & 0 & 0 & - {x}_{B} {x}_{{B}^{′}} & - {y}_{B} {x}_{{B}^{′}} \\ 0 & 0 & 0 & {x}_{B} & {y}_{B} & 1 & - {x}_{B} {y}_{{B}^{′}} & - {y}_{B} {y}_{{B}^{′}} \\ {x}_{C} & {y}_{C} & 1 & 0 & 0 & 0 & - {x}_{C} {x}_{{C}^{′}} & - {y}_{C} {x}_{{C}^{′}} \\ 0 & 0 & 0 & {x}_{C} & {y}_{C} & 1 & - {x}_{C} {y}_{{C}^{′}} & - {y}_{C} {y}_{{C}^{′}} \\ {x}_{D} & {y}_{D} & 1 & 0 & 0 & 0 & - {x}_{D} {x}_{{D}^{′}} & - {y}_{D} {x}_{{D}^{′}} \\ 0 & 0 & 0 & {x}_{D} & {y}_{D} & 1 & - {x}_{D} {y}_{{D}^{′}} & - {y}_{D} {y}_{{D}^{′}}\end{matrix} ] [ \begin{matrix}{v}_{1} \\ {v}_{2} \\ {v}_{3} \\ {v}_{4} \\ {v}_{5} \\ {v}_{6} \\ {v}_{7} \\ {v}_{8}\end{matrix} ]$$

The coefficients of the transformation matrix can then be obtained by solving the 8 simultaneous equations.

$$[ \begin{matrix}{v}_{1} \\ {v}_{2} \\ {v}_{3} \\ {v}_{4} \\ {v}_{5} \\ {v}_{6} \\ {v}_{7} \\ {v}_{8}\end{matrix} ] = {[ \begin{matrix}{x}_{A} & {y}_{A} & 1 & 0 & 0 & 0 & - {x}_{A} {x}_{{A}^{′}} & - {y}_{A} {x}_{{A}^{′}} \\ 0 & 0 & 0 & {x}_{A} & {y}_{A} & 1 & - {x}_{A} {y}_{{A}^{′}} & - {y}_{A} {y}_{{A}^{′}} \\ {x}_{B} & {y}_{B} & 1 & 0 & 0 & 0 & - {x}_{B} {x}_{{B}^{′}} & - {y}_{B} {x}_{{B}^{′}} \\ 0 & 0 & 0 & {x}_{B} & {y}_{B} & 1 & - {x}_{B} {y}_{{B}^{′}} & - {y}_{B} {y}_{{B}^{′}} \\ {x}_{C} & {y}_{C} & 1 & 0 & 0 & 0 & - {x}_{C} {x}_{{C}^{′}} & - {y}_{C} {x}_{{C}^{′}} \\ 0 & 0 & 0 & {x}_{C} & {y}_{C} & 1 & - {x}_{C} {y}_{{C}^{′}} & - {y}_{C} {y}_{{C}^{′}} \\ {x}_{D} & {y}_{D} & 1 & 0 & 0 & 0 & - {x}_{D} {x}_{{D}^{′}} & - {y}_{D} {x}_{{D}^{′}} \\ 0 & 0 & 0 & {x}_{D} & {y}_{D} & 1 & - {x}_{D} {y}_{{D}^{′}} & - {y}_{D} {y}_{{D}^{′}}\end{matrix} ]}^{- 1} [ \begin{matrix}{x}_{{A}^{′}} \\ {y}_{{A}^{′}} \\ {x}_{{B}^{′}} \\ {y}_{{B}^{′}} \\ {x}_{{C}^{′}} \\ {y}_{{C}^{′}} \\ {x}_{{D}^{′}} \\ {y}_{{D}^{′}}\end{matrix} ]$$

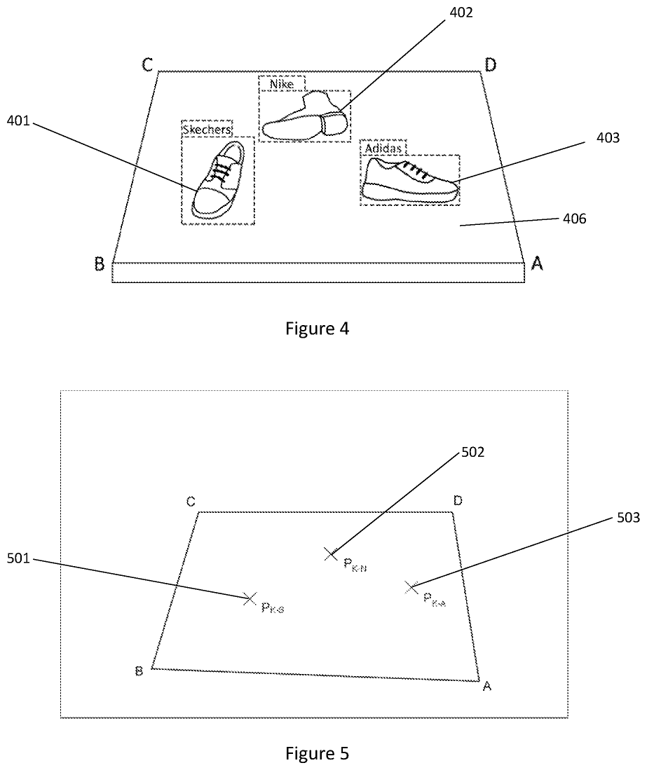

The AI system is then applied to detect if any trained article 401, 402, 403 appear on top of the table 406 (AOI) in the real-time video stream obtained via the camera 230 as shown in FIG. 4.

As now shown in FIG. 5, if articles are detected, the corresponding centre coordinates 501, 502, 503 of the articles 410, 402, 402 of FIG. 4 are calculated from the rectangle output from the AI system.

Depending on accuracy of the AI engine and noise in the images therein, the rectangles surrounding identified articles 401, 402, 403 may be fluctuating or missing in short occasion. Application of 2D invariant such as a Kalman filter may be used to smoothen the noise and inaccuracy so that the output coordinates are stable even if the original data is fluctuating. The smoothened coordinates are then transformed into projector coordinates with projective matrix.

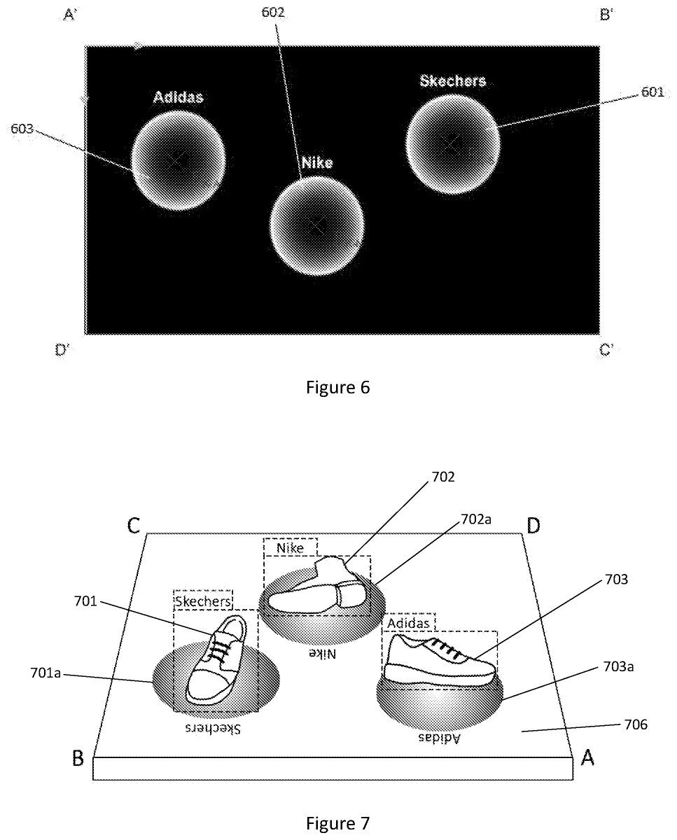

In the present example as shown in FIG. 6, software is provided to display bright circular spotlight-like graphics 601, 602, 603 together with some primary information, such as brand of the product, onto the articles via the projector 230.

Because the spotlight coordinates are calculated via the real-time streaming of the camera 230 image, the spotlights trace the motion of the articles interactively.

Whether an article has been picked up from the table by the customer, it is detected by monitoring the following in real-time:
Fast movements of the article coordinates
Article center outside the AOI, e.g. above the table area in our example
The detected article disappeared from the camera image.

If no detected articles are picked up, as is illustrated in FIG. 7, that all articles 701, 702, 703 are placed on top of the table 706, spotlights 701a, 702a and 703a will be overlaid onto the articles. Corresponding primary information such as the brand would also be shown next to the articles.

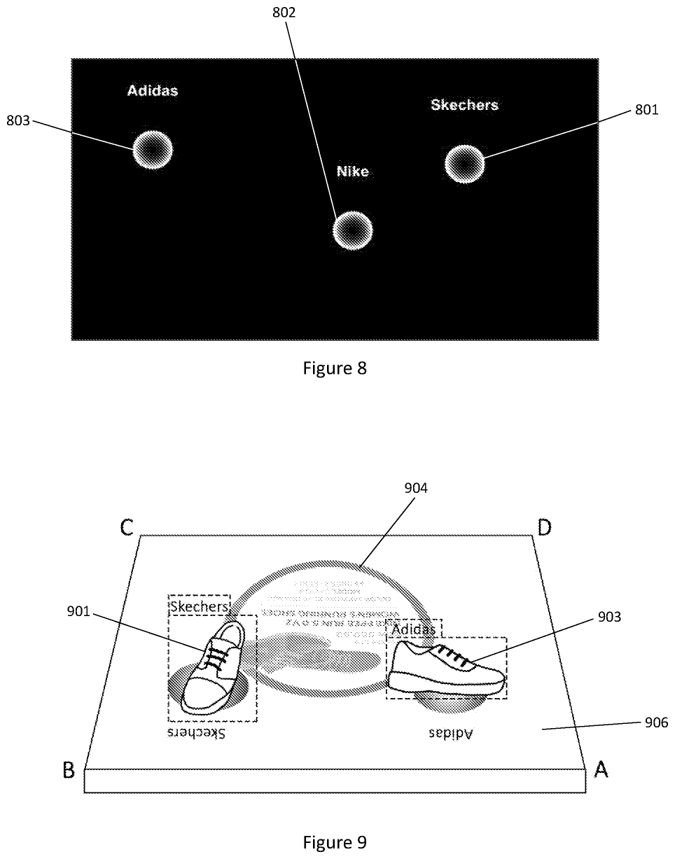

FIG. 8 shows the output projector image of the spotlight graphics and the primary information. The coordinates positions of the spotlight graphics and the primary information are arranged such that when the image is projected on the AOI, the spotlight graphics 801, 802, 803 are overlaid with the corresponding articles.

Referring to FIG. 9 when the system can only detect the presence of articles 901 and 903 on the table 906 (AOI) but not the position of the other article, it can be deduced that such article is being picked up from the table 906 by a customer for further inspection.

In order to provide more details of the picked-up article to the customer, corresponding interactive response 904 in the form of multi-media, including pricing, new or hot or popular items of related brands, styles, related recommendation or the like, may then be displayed.

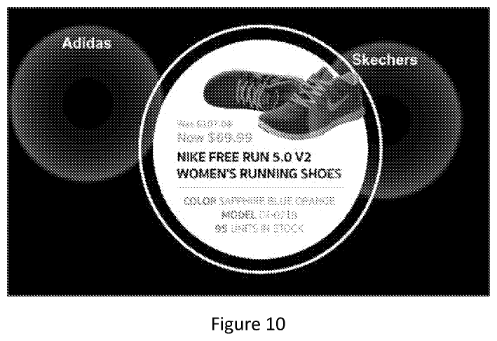

The projection image of which includes the price, the brand and the description of the article is shown in FIG. 10.

The recorded customer's behavior, such as age and gender, emotion on the products, preference categories, hot items, popular or frequently considered items or the like, can be used in sales analytics.

This can help retailers to track or monitor a consumer or potential customer's shopping behavior, their interest level and appeal towards particular product or item and whether a consumer or potential customer has picked up product for viewing and consideration, which provides useful commercial information to further assist customers.

1. A computerized system for providing article information to a customer, said system comprising: an optical image acquisition device for acquiring an optical image of an area of interest (AOI) in which articles are display to a customer; a processor module operably in communication with the optical image acquisition device and for receiving an image input signal therefrom; and an output device in communication with the processor for providing an output signal to a customer; wherein upon the processor detecting the article being removed from the area of interest (AOI), the processor sends an output signal having article data associated with said article to said output device, and said output device provides an output to the customer of said article data.

2. The computerized system according to claim 1, wherein said output device is a projector device, and wherein said projector device provides visual article data.

3. The computerized system according to claim 2, wherein said AOI is a table.

4. The computerized system according to claim 3, wherein the projector device projects the article data onto said table.

5. The computerized system according to claim 1, wherein the processor determines said article by way of artificial intelligence (AI).

6. The computerized system according to claim 1, wherein the system utilises optical recognition of facial expressions, so as to ascertain the appeal by a subject in relation to said article.

7. The computerized system according to claim 1, wherein the output device is a projector device, and the processor ascertains the position of the article in the AOI in real time, and the projector device provides an image to the AOI in real time.

8. The computerized system according to claim 7, wherein the AOI is a table, and the image is a representation of a spotlight.

9. A process operable using a computerized system for providing article information to a customer, the computerized system including an optical image acquisition device, an output device in communication with the processor for providing an output signal to a customer, said process including the steps of: obtaining an optical image of one or more articles in an area of interest (AOI) a subject using optical image acquisition device; by the processor, determining if an article has been removed by a customer from the AOI; and by output device the providing article information to a customer.
